(19) United States
(12) Patent Application Publication
(10) Pub. No.: US 2014/0069182 A1
(43) Pub. Date: Mar. 13, 2014

(54) TESTING APPARATUS AND METHOD

(71) Applicant: UNIVERSITY OF LIMERICK, Limerick (IE)

(72) Inventors: Conny SCHMIDT, County Clare (IE); Trevor YOUNG, County Clare (IE); Emmanuel BENARD, Castanet-Tolosan (FR)

(73) Assignee: UNIVERSITY OF LIMERICK, Limerick (IE)

(21) Appl. No.: 13/972,435

(22) Filed: Aug. 21, 2013

(30) Foreign Application Priority Data
Sep. 13, 2012 (IE) 2012/0398

(51) Int. Cl. G01M 9/04

(52) U.S. Cl. CPC G01M 9/04
USPC 73/147

(57) ABSTRACT

An apparatus for testing effects of relative movement of a fluid and an object has a test chamber (3) arranged to contain a fluid and is open in a manner to allow fluid inlet and/or outlet while the movable surface is moving. There is a drive (1) for moving a movable surface (13) with respect to the fluid in the chamber, and a probe for monitoring fluid conditions within the test chamber. The chamber has an inlet (5) and a separate outlet (6), and the drive is arranged to rotate a rotor (1) having the movable surface (13).

### FIELD OF THE INVENTION

The invention relates to testing of the flow of objects through fluids containing smaller scale particles, such as for instance aircraft approaching ice crystal containing cirrus clouds.

### PRIOR ART DISCUSSION

It is well known that if a laminar boundary layer state can be achieved over much of the surface of an object, then friction drag can be much reduced. For future aircraft equipped with laminar flow technology, it is beneficial to test for prototype development with re-creation of an environment with fluid mimicking flight through clouds such a cirrus clouds. Such conditions are difficult to achieve in a conventional wind tunnel.

For several decades it has been recognized that ice crystals occurring in cirrus cloud would have a detrimental effect, and in fact that laminar flow can be entirely lost when entering thick cirrus cloud and degraded even in light cirrus haze.

Subsequent theoretical analysis (in conjunction with results obtained from flight tests) proposed the existence of a minimum critical particle size and a minimum ice crystal concentration, both of which must be exceeded for any effect to occur. In other words, if particles of larger than critical dimensions are present at higher than minimum concentrations, the achievable extent of laminar flow reduces with particle flux until a level is reached where the boundary layer is entirely turbulent.

The invention is directed towards achieving a simpler and/or more effective apparatus and method for laboratory testing of operational flight conditions.

### GLOSSARY OF TERMS

BC=Boundary Condition
CFD=Computational Fluid Dynamics
LEFT=Leading Edge Flight Test program
LFC=Laminar Flow Control
LFT=Laminar Flow Technology
NASA=National Aeronautics and Space Administration (USA)
rpm=rotations per minute
d=particle diameter=
l=length of particle
Re=Reynolds number
t=time
u, U=stream-wise velocity
y=wall-normal distance
υ=kinematic viscosity
δ=boundary layer thickness

### REFERENCES

[1] Arnal, D. & Archambaud, J. P. Laminar-Turbulent Transition Control: NLF, LFC, HLFC, AVT 151 Lecture Series on Advances in Laminar-Turbulent Transition Modelling, Jun. 9-13, 2008, von Karman Institute for Fluid Dynamics, Brussels.
[2] Schrauf, G. & Kühn, W. Future Needs and Laminar Flow Technology, Air & Space Europe, No. 3/4, Vol. 3, May-August 2001, pp. 98-100.
[3] Young, T. M. and Fielding, J. P. Potential Fuel Savings due to Hybrid Laminar Flow Control under Operational Conditions, Aeronautical Journal, Vol. 105 (1052), 2001, pp. 581-588.
[4] IATA, Airline & Operations, Fuel Conservation, accessed online, 29 Jul. 2011, http://www.iata.org/whatwedo/aircraft_operations/fuel/pages/fuel_conservation.aspx.
[5] Hall, G. R. On the Mechanics of Transition Produced by Particles Passing Through an Initially Laminar Boundary Layer and Estimated Effect on the Performance of X-21 Aircraft, Northrop Corp., Contract-No.: N79-70656, 1964.
[6] Fowell, L. R. & Antonatos, P. P. Some Results from the X-21A Program, AGARDograph, Part I, Recent Developments in Boundary Layer Research, May 1965
[7] Davis, R. E., Maddalon, D. V., Wagner, R. D. Performance of Laminar Flow Leading Edge Test Articles in Cloud Encounter, NASA CP-1987-2487, Langley Research Center, 1987.
   [8] Pfenninger, W. Design Considerations of Long-Range and Endurance LFC Airplanes with Practically All Laminar Flow, NASA Joint Institute for Advancement of Flight Sciences, August 1982.
[9] Hall, G. R. Interaction of the wake from bluff bodies with an initially laminar boundary layer, AIAA Journal, V. 5, No. 8, pp. 1386-1392, 1965.
[10] Hall, G. R. Interaction of the wake from bluff bodies with an initially laminar boundary layer, AIAA-1966-126, Aerospace Sciences Meeting, 3^{rd}, New York, N.Y., January 24-26, Paper 66-126, 1966.
[11] Ladd, D. M. & Hendricks, E. W. The effect of background particulates on the delayed transition of a heated 9:1 ellipsoid, Exp. in Fluids., V. 3, 1985, pp. 113-119.
[12] Lauchle, G. C. & Gurney, G. B. Laminar Boundary Layer Transition on a Heated Underwater Body, J. Fluid Mech., V. 144, 1984, pp. 79-101.
[13] Lauchle, G. C., Petrie, H. L., Stinebring, D. R. Effects of Particulates on the Delayed Transition of a Heated Body, Applied Research Laboratory Technical Memorandum 86-213, 1986.
[14] Lauchle, G. C., Petrie, H. L., Stinebring, D. R. Laminar Flow Performance of a Heated body in particle-laden water, Exp. in Fluids, Vol. 19, 1995, pp. 305-312.
[15] Mochizuki, M. V. Smoke Observation on Boundary Layer Transition Caused by a Spherical Roughness Element, J. Phys. Soc. of Japan, Vol. 16, No. 5, pp. 995-1007.
[16] Petrie, H. L., Morris, P. J., Bajwa, A. R., Vincent, D. C. Transition induced by Fixed and Freely Convecting Particles in Laminar Boundary Layers, 1993, The Pennsylvania State University, Appl. Res. Lab., PA, USA.
[17] Roshko, A. On the Development of Turbulent Wakes From Vortex Stresses, NACA TR-1191, Langley Research Center, 1954.
[18] Sakamoto, H. & Haniu, H. A Study on Vortex Shedding From Spheres in a Uniform Flow, J. Fluid Eng., V. 112, ASME, 1990, pp. 386-392.
[19] Sakamoto, H. & Haniu, H. The formation mechanism and shedding frequency of vortices from a sphere in uniform shear flow, J. Fluid Mech., V. 287, 1995, pp. 151-171.
[20] Schlichting, H. Boundary Layer Theory, 7th Edition, McGraw-Hill Book Company, 1979.
[21] Schmidt, C. & Young, T. M., The impact of Cirrus Cloud on Laminar Flow Technology, 7^{th} AIAA Aviation technology, Integration and Operations Conference (ATIO), 18-20 September, Belfast, Northern Ireland, 2007.
[22] Schmidt, C. & Young, T. M., The impact of freely suspended particles on laminar boundary layers, 47^{th} AIAA Aerospace Sciences Meeting (ASM), 5-8 January, Orlando, Fla., USA, 2009.
[23] Schmidt, C., Young, T. M., Benard, E. P., Atalay, S. The influence of cirrus cloud on drag reduction technologies based on laminar flow, CEAS/KAT net II Conference on Key Aerodynamic Technologies, 12-14 May, Bremen, Germany, 2009.
[24] Vincent, D. C. Transition induced by Fixed and Freely Suspended Spherical Particles in Laminar Boundary Layers, Master thesis, Aerospace Engineering Department, The Pennsylvania State University, 1993.
[25] Bell, J. H., Metha, R. D. Boundary Layer Predictions for Small Low-Speed Contractions, AIAA Journal, March 1989, Vol. 27, No. 3, pp. 372-374.
[26] Brassard, D., Ferchichi, M. Transformation of a Polynomial for a Contraction Wall Profile, ASME, J. of Fluid Eng., January 2005, Vol. 127, pp. 183-185.

### SUMMARY OF THE INVENTION

According to the invention there is provided an apparatus for testing effects of relative movement of a fluid and an object, the apparatus comprising:
a test chamber arranged to contain a fluid;
a drive for moving a movable surface with respect to the fluid in the chamber; and
a probe for monitoring fluid conditions within the test chamber.

In another aspect the invention provides a method of testing fluid conditions near a boundary layer where there is relative movement of a surface and surrounding fluid, the method comprising the steps of:
moving the movable surface of an apparatus of any embodiment;
introducing at least one particle into the test chamber adjacent to the movable surface; and
monitoring fluid conditions within the test chamber.

In one embodiment, the chamber is open in a manner to allow fluid inlet and/or outlet while the movable surface is moving.

In one embodiment, the chamber has an inlet and a separate outlet.

In a further embodiment, the drive is arranged to rotate a rotor having the movable surface.

In one embodiment, the chamber is curved around the path of the movable surface.

In one embodiment, the apparatus further comprises a conduit for fluid flow into the inlet.

In another embodiment, the conduit includes a narrowing section.

In one embodiment, said narrowing section is preceded by a settling section of larger cross-sectional area.

In a further embodiment, the settling section includes a flow conditioner such as a honeycomb structure or a wire gauze.

In one embodiment, the outlet is linked with a downstream diffuser.

In one embodiment, the apparatus further comprises means to introduce the probe from a wall of the test chamber.

In one embodiment, the apparatus further comprises means for introducing one or more particles into the test chamber.

In another embodiment, the apparatus comprises a support for supporting a particle in the test chamber. In one embodiment, the support comprises a rod. In one embodiment, the rod is movable to adjust position of the particle with respect to the movable surface.

In one embodiment, the support is adapted to move a particle in directions either normal to the movable surface or in the direction of a fluid stream as the surface is moving.

In one embodiment, the support is adapted to move a particle to simulate an impact of the particle with the movable surface.

In another embodiment, the apparatus further comprises means for changing pressure in the test chamber.

In one embodiment, the apparatus further comprises means for introducing pressure gradients into the test chamber.

In one embodiment, the apparatus further comprises means for changing temperature in the test chamber.

### DETAILED DESCRIPTION OF THE INVENTION

### Brief Description of the Drawings

The invention will be more clearly understood from the following description of some embodiments thereof, given by way of example only with reference to the accompanying drawings in which: —

FIG. 1 is a diagram illustrating a test apparatus of the invention;

FIGS. 2 to 5 are diagrams illustrating aspects of particle-laden fluid flow near a solid surface which shall be investigated using the apparatus of FIG. 1, showing comparisons of in-realty occurring mechanisms to those normally prevailing in conventional laboratory approaches;

FIG. 6 is a CFD analysis plot of a laminar boundary layer velocity profile determined mid-way between an apparatus inlet and outlet;

FIG. 7 is a pair of images showing smoke flow visualization during testing;

FIG. 8 is a set of velocity profiles as obtained from wall-normal traverses of a standard Pitot tube during initial testing;

FIG. 9 is a velocity profile as obtained from a wall-normal traverse of a miniature flattened Pitot tube subsequent to modifications targeted to improve the performance of the apparatus; and

FIG. 10 is an image of a thin streak of smoke entrained from a small hole in a spherical particle and drawn along with the air accelerated by the drum rotating at 120 rpm, in which the image (a) is an actual captured image and (b) is a post-processed illustration of (a) to enhance clarity.

### DESCRIPTION OF THE EMBODIMENTS

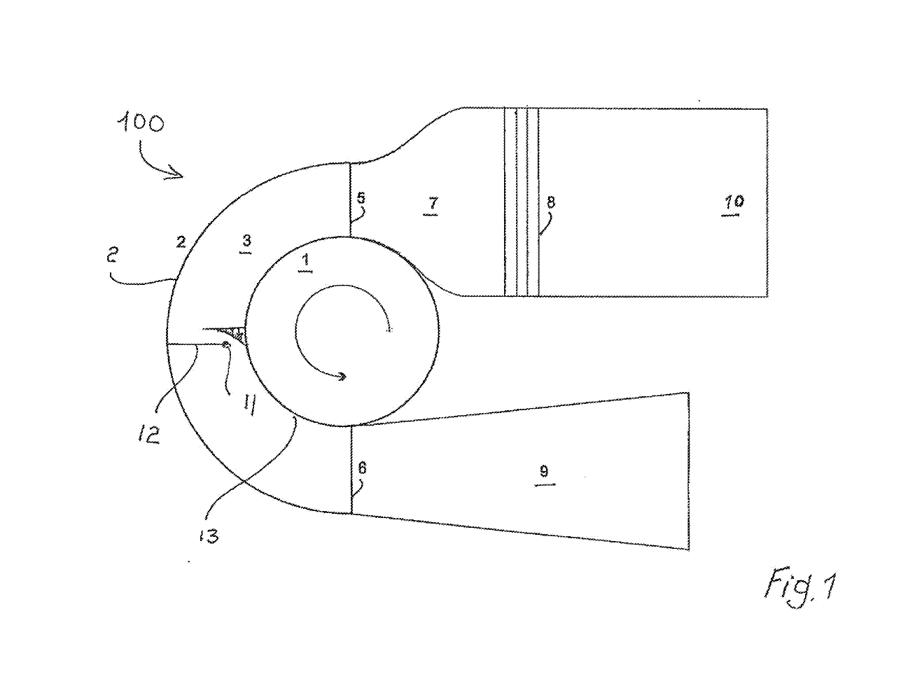

Referring to FIG. 1 a testing apparatus 100 comprises a rotational drum 1 and a test section wall 2 defining a test section 3.

The rotational drum 1 can be rotated in order to provide for a moving surface 13 at the inner side of the test section 3. The arrow drawn at the inside of the rotational drum 1 indicates that this motion is anti-clockwise as viewed here, but it may alternatively be clockwise. The test section is bent around the drum with a squared cross-sectional area of 210 mm side length. The rotational drum 1 provides an entire side wall of the test section; however in other embodiments it may provide only a portion of it (in terms of its width or its length or both) depending on a particular experiment. Similarly, the actual height and width of the test section 3 will be defined by a specific investigation, whereby blockage due to a growing boundary layer and side wall effects should be considered (in fact, the cross-sectional dimensions could be any multiple of the ones given here, being kept constant or not over the test section length; also, the cross-sectional shape could be different to the rectangular one illustrated here) The outer test section wall 2 is shaped to provide for a desired pressure gradient. In this embodiment, a zero pressure gradient is considered as being ideal; however, by an appropriate design of the wall contour any other pressure gradient, constant or varying, can be achieved. In other words, different embodiments may involve non-constant cross-sectional areas, or flaps or grids near or in the diffuser, or both. While the former is frequently used to provide for a varying pressure gradient (e.g. by specifically designed test section walls with variable geometries), the latter is commonly applied to generate a uniform pressure gradient.

The drum 1 can be rotated at up to 350 rpm and replaces the inner wall of a semicircular test section with a square cross-sectional area of 210 mm a side length. The drum's diameter amounts to 322 mm providing for a run length of approximately 1 m per rotation. However, in different embodiments all these parameters/dimensions may vary.

A test section inlet 5 and a test section outlet 6 are provided. However, in different embodiments one or other may not exist; meaning that one or both could be closed for a specific reason. In the case of the embodiment of FIG. 1 the inlet is open and is attached to a contraction conduit 7 preceded by a settling chamber 8 containing flow conditioners (e.g. honeycombs and/or wire gauzes). This is to ensure that the flow drawn into the test section 3 due to the movement of the rotational drum 1 from the inlet side is of suitable, sufficiently disturbance-free quality. Additionally, the parts 7 and 8 condition the flow when added from an optional additional flow supply 10, which, in FIG. 1, is located at the inlet side, but may alternatively be placed at the outlet side. The outlet 6 (configured as open in the apparatus 100) is connected to a diffuser 9 in order to allow for the flow sustained from the test section 3 to moderately expand and then to discharge to the environment.

Using the apparatus 100 a researcher can investigate the effect of particles and/or their wakes on a boundary layer for the case of the particles being in equilibrium (or near to it) with the carrier fluid within the free stream or, respectively, at the edge of a boundary layer before entering it.

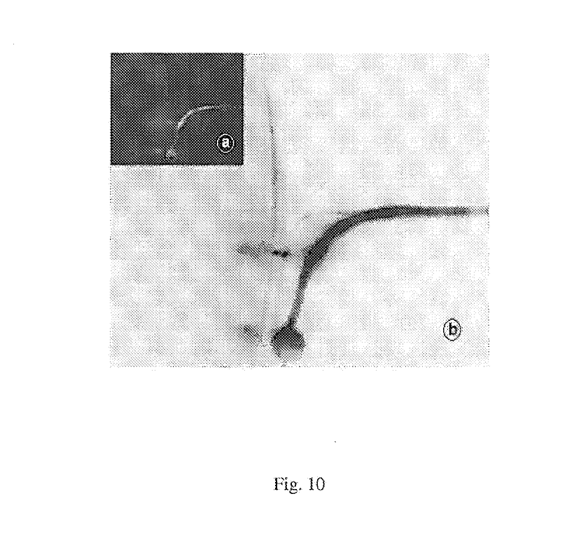

A particle is defined as any object being able to produce a wake within a fluid due to its existence and its relative velocity to that of the fluid. FIG. 1 shows a particle 11 supported in a fixed position on a thin rod 12. This is equivalent to a particle of for example a cirrus cloud. Of course in reality such a particle can be considered static with respect to an airplane moving towards it. In the system 100 the particle 11 is static and the effect it creates near the surface of the drum 1 can be investigated. The sensing may be visual if smoke is introduced and an example image is shown in FIG. 10. The sensing may be performed using any of the known wind-tunnel techniques, such as the hot wire method in which a very thin wire at an elevated temperature traverses behind the particle and its temperature change indicates the extent of flow.

A boundary layer is defined as any shear layer developing in a fluid. This can be a wall-bounded flow over a rigid (or flexible) body, but shall also include all shear layers which develop freely at the interface(s) of two or more fluids flowing with different velocities relative to each other, whereby the fluids can be of different or of one and the same matter. Furthermore, for the above description a velocity of zero may be defined as ‘flowing’.

A fluid is defined as any matter that is capable of flowing; it may be gaseous (including rarefied flows) or liquid (or a member of slug flows).

The apparatus 100 reverses the commonly-employed approach of a wind tunnel (or water channel). It does so by moving a surface within a test section that is filled with a fluid that is at rest or at a very low, sub-critical, speed. This allows investigation of the effect of particles (as well as their wakes) moving with the flow on a shear layer when entering it, which is achieved by a simulation of all four in-reality occurring mechanisms as illustrated in FIGS. 2a, 3a, 4b and 5b simultaneously.

Rotating the drum 1 will result in the adjacent fluid particles (molecules) to adhere to it due to the no-slip conditions. As the remainder of the fluid is at rest (or moving at a very slow, “sub-critical” speed) the fluid particles further away from the drum's surface will be more and more reluctant to follow this movement until they simply remain at their initial state, which will result in a boundary layer-like composition. Even though this setup involves curvature, a constant cross-sectional area will assure near-zero pressure gradient conditions in the vicinity of the moving surface 13. It is envisaged that after a certain period of run-time an equilibrium state will be established that is comparable to a boundary layer shape that would normally be found over a flat plate in a conventional wind tunnel/water channel at zero angle of attack.

In order to control the thickness of the boundary layer, the introduction of a slight flow in the direction opposite to the rotation of the drum might be required. In this case, the introduction of additional air (or other fluid) supply would be needed; this may be in the form of pressurized air or introduced by a fan or any other means.

The parameters of the particles, whose effect on the boundary layer shall be investigated, can easily be controlled by introducing the particles from any of the fixed test section walls (in this case preferably the outer wall 2). For example, the particle's vertical velocity component can be either reduced to zero or set to any desired speed by an appropriate mechanical device. Furthermore, the process can be halted at any desired elevation from the drum's surface. With the apparatus 100 an environment has been created in which the mechanisms are reduced to what an observer would see if he was travelling with the particle in the reality case. In the embodiment of FIG. 1 the particle 11 is moved translationally by sliding movement of the rod 12.

Of additional advantage is that the support rod 12 and any sensors and their supports may be located within sub-critical regions until advancing well into the boundary layer. This will reduce interference and result in holder choices to be less restrictive than customary. Should the investigator choose to introduce additional flow into the test section 3 in order to achieve a desired flow condition for a particular experiment, care should be taken to avoid losing the above-described benefits.

The velocity of the experiments can be set very precisely by increasing or decreasing the rotational speed of the drum 1. This degree of accuracy can normally not be achieved in conventional wind tunnels at low velocities.

The drum 1 can be made of any chosen material that can be suitably manufactured to the required tolerances, and vibration can be brought to a minimum by carefully balancing the equipment. It is advised to run the facility in quiet, vibration-free environment.

Referring to FIGS. 2 to 5, FIGS. 2a and 2b relate to a freely-suspended particle entering a boundary layer and illustrate the changing ratio of its wall normal and stream-wise velocity components due to alterations of the free stream speed by showing the corresponding velocity vector components of that particle at high (FIG. 2a) and at low free stream velocity (FIG. 2b).

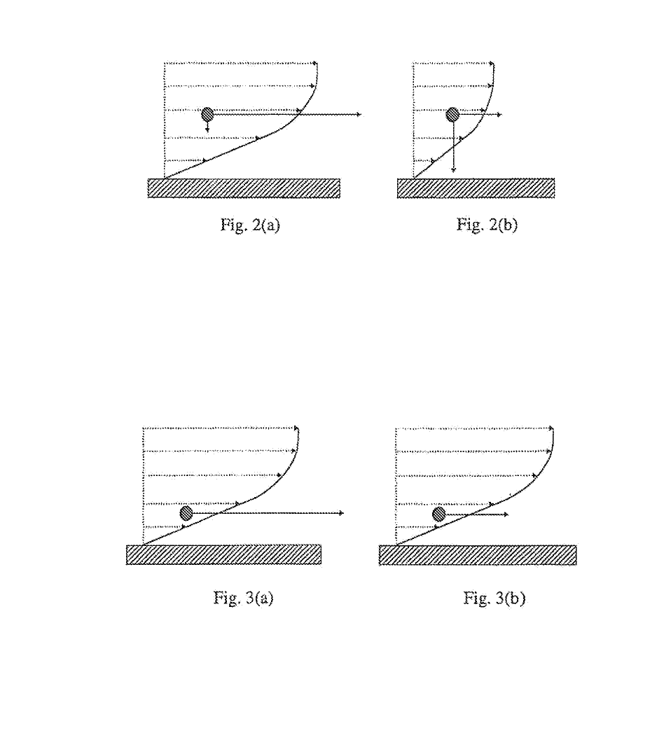

FIGS. 3a and 3b relate to a freely suspended particle entering a boundary layer and depict the adaptation of its stream-wise velocity component due to alterations of the density ratio between such a particle and the carrier fluid by showing the original case of an ice crystal in air (FIG. 3a) and a nearly neutrally buoyant particle (FIG. 3b).

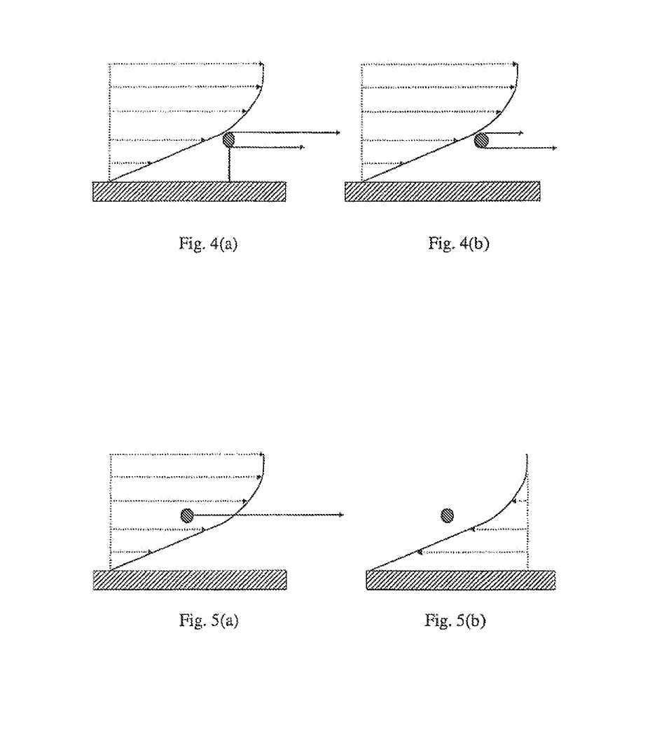

FIGS. 4a and 4b illustrate the relative velocity magnitude experienced by a particle immersed in a boundary layer at each of its sides (top and bottom) showing the prevailing situations for a fixed (FIG. 4a) and a freely suspended particle (FIG. 4b), where it should be noted that in the suspended case the particle will develop its wake in the opposite direction.

FIGS. 5a and 5b show the differences in the orientation of the boundary layer velocity vectors in the situations as occurring in the laboratory (FIG. 5a) and in reality (FIG. 5b).

The apparatus 100 is used for investigating the impact of an object (that is in or nearly in equilibrium to the free stream) or of its wake (caused by movement of the object relative to the carrier fluid) on the fluid's shear layer developing when the carrier fluid flows over a surface (or over another fluid moving at a different speed).

The flow conditions may be altered in terms of:
using different flow media, commonly called ‘fluid’, which may be liquid (including their wide range of viscosities) or gaseous (including compressed and rarefied conditions);
increasing or decreasing the pressure within the test section;
increasing or decreasing the temperature within the test section.

The apparatus may have a settling chamber (potentially including flow conditioners such as honeycomb grids and/or wire gauzes) and a contraction area attached to the inlet and a diffuser to the outflow of the test section. It may include or omit any of the components on either side of the test section, used individually or in any combination.

The apparatus 100 may exchange inlet and outflow conditions, by a reversed operation of the rotational drum. There may be additional flow (or flows) from either side of the test section by typically in wind tunnel or water channels applied methods (including fans, compressors or other known means of forcing a liquid or gaseous medium to flow in a desired direction). Also, there may be in- or outflow of a fluid through any of the test section walls (e.g. through slots, holes, perforations etc.). There may be geometrical movement of any of the other test section walls in addition to that of the rotational drum.

Variation of the test apparatus may have any or all of:
a closed test section with an open in- and outflow;
a closed test section in a open loop configuration;
a closed test section in a closed loop return type configuration;
an open throat type test section with an open in- and outflow;
an open throat type test section in a open loop configuration;
an open throat type test section in a closed loop return type configuration;
any above mentioned closed loop return type configurations that can be enclosed such as to allow for pressurizing (positively or negatively) the entire system;
any above mentioned configurations that includes means for heating or cooling the carrier fluid;
introduction of freely flowing particles from a test chamber wall, instead of particles being held on a support.

The shear layer, on which the impact of an object (or its wake) shall be investigated, may be of laminar nature, of transitional nature, or of turbulent nature.

The shear layer, on which the impact of an object (or its wake) is investigated may:
represent a boundary layer developing over a solid wall,
represent a boundary layer developing over a flexible wall,
represent a free shear layer between two fluids of one and the same matter flowing relative to each other at different velocities, or
represent a free shear layer between two fluids of different matter flowing relative to each other at different velocities

The particle or particle(s) being investigated may:
be of a simple geometry (like for instance spherical, cylindrical, and ellipsoidal) or of any other irregular shape;
inherit a smooth surface or any other surface characteristic (like for instance rough or porous);
be rigid or deformable, soluble or not, chemically reactant or not, evaporating or not, hydrophilic or not, growing or shrinking or of constant size, in any combination;
be of a size smaller than the local boundary layer thickness at the anticipated measurement location or larger than that;
be of solid, liquid or gaseous matter (or a combination thereof) as long as it is possible to clearly distinguish a definite interface between the object and the carrier fluid (at least for a short period of time), which will depend on the matter of fluid chosen for a particular experiment;
represent any kind of entity that is able to produce (at least for a short period of time) a wake due to its existence and a relative movement to the carrier fluid;
held at a fixed position; or
translated or rotated within the test section in all six degrees of freedom in the three-dimensional space.

The moving surface (provided above in the form of a rotational drum) may be replaced by a conveyer belt, may it be in a circular, or in a straight, or in any other suitable arrangement.

The invention allows for positioning the particle, the impact of which shall be investigated, at a fixed location, while at the same time processes could be slowed down, thus providing for relatively thick boundary layers. Additionally, important key features, as for instance the direction of the velocity vectors (FIGS. 5(a) and 5(b)), the position of the critical condition (FIGS. 4(a) and 4(b)), and the insignificance of the particles' wall normal velocity component (FIGS. 3(a) and 3(b)), are preserved. Furthermore, the issue of a diminishing relative velocity between the particle and the carrier fluid (within the boundary layer) in cases where their density ratio cannot be kept comparable to the actual occurrences (e.g. in a water channel) is satisfactorily overcome while making occurring processes entirely independent of this influence. Conventionally, e.g. for the study of e.g. the impact of ice crystals on a laminar boundary layer maintained over an aircraft's structure, meaningful experiments were previously limited to gaseous flow.

The invention is expected to shed further light onto the mechanisms occurring when investigating the effect of particles that are in or near equilibrium to a carrier fluid before entering a shear layer. It is believed to be a suitable approach for investigating the wake development of a particle immersed into a wall-bounded non-uniform shear flow, thus being capable of identifying the needed (and yet undetermined) critical particle parameters.

According to theory (First Stokes Problem), however, the boundary layer over an infinitely large flat plate set suddenly into motion is proposed to grow as:

δ=3.6\sqrt{vt} Eq. 1

In other words, the boundary layer will steadily continue to thicken with time. Nevertheless, Eq. 1 describes a mathematical model based on boundary conditions that do not necessarily apply to practical applications. For instance, when imagining a plate attached to an aircraft (in parallel to its flight direction), the initial condition at its leading edge would be constantly reset to zero, since fresh air parcels (being “quasi-at-rest”) are continuously approached. The anticipated method aims at achieving similar conditions by forcing a constant rebuild of the prevailing boundary layers due to a wind-tunnel-like configuration.

A preliminary Computational Fluid Dynamics (CFD) study was undertaken. The most critical features, namely the rotational drum and its enclosing semicircular test section, were investigated. Using the GAMBIT/FLUENT software package the required computational mesh was generated, whereby much consideration was given to defining suitable boundary conditions (BC). They were set to either in/outflow or pressure in/outlet. The drum was defined to rotate at a speed of 4 m/s (25 rad/s).

Due to the steady build-up of the boundary layer (as expected from theory) the simulations were run with an unsteady solver. Surprisingly, the initially rapid boundary layer growth stopped after only a few seconds of simulated time. Thereafter, only minor changes in the boundary layer thickness were apparent.

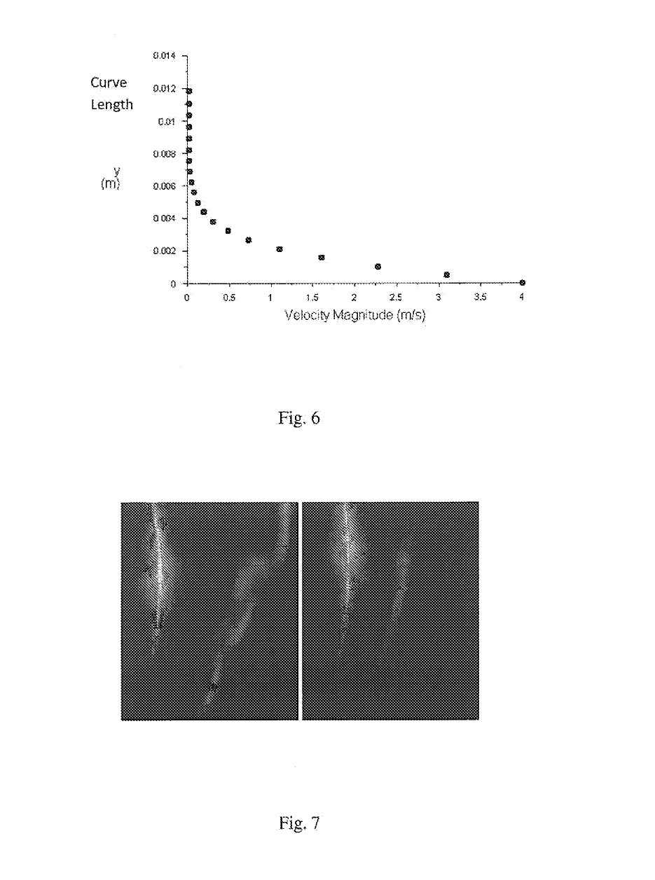

FIG. 6 shows a “quasi-steady” laminar solution of the boundary layer at a position half way between the inlet and the outlet. The resulting boundary layer thickness was found to be somewhat larger than, for example, a Blasius solution, even though the constant cross sectional area throughout the test section length should provide for a near zero pressure gradient condition. This can probably be attributed to some inertial forces due to the involved curvature.

Initial tests traversing a standard Pitot tube in the wall normal direction resulted in somewhat fuller velocity profiles when compared to the numerical prediction. Furthermore, the thickness of the developing shear layer raised concerns that the flow could be turbulent and emphasized the requirement to appropriately characterize the flow. Therefore, flow visualization was conducted using a 5 mW laser light sheet and smoke which was introduced from the contraction close to the position where the shear layer over the drum begins to develop.

The illustration of FIG. 7 left image clearly shows turbulent structures along what is believed to be the edge of the shear layer. Subsequent modification of the inflow conditions resulted in the situation of the right hand image, making apparent the achieved improvement.

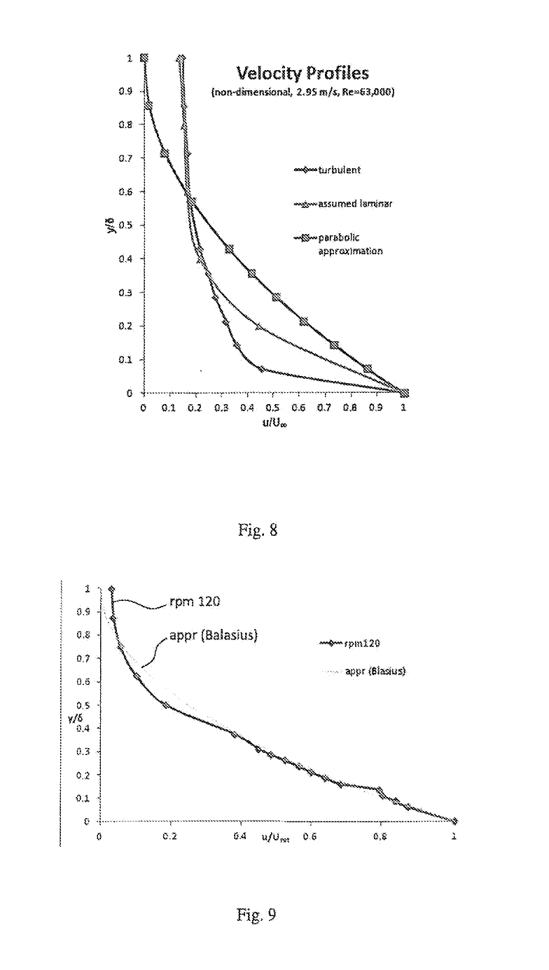

Both situations have also been investigated by Pitot tube traverses. FIG. 8 shows the obtained boundary layer profiles in non-dimensionalized parameters, together with a parabolic approximation (as proposed by von Karman) of a flat plate laminar boundary layer velocity profile as a reference:

$$\frac{u}{U} = 2 \frac{y}{δ} - \frac{{y}^{z}}{{δ}^{z}} \qquad Eq . 2$$

The measurements were taken near the centerline at a location about 300 mm downstream of the test section inlet for a drum rotation of 175 rpm, thus approximately 2.95 m/s. This provided for a length Reynolds number, Re, of 63,000.

As is apparent from FIG. 8, a certain amount of stream-wise flow velocity could be detected throughout the entire height of the test section amounting to about 15% of the rotational speed. Nevertheless, a boundary layer like flow profile develops near the drum. The measurements have been found to be repeatable. Thus, a stable equilibrium of the flow field has been achieved.

Furthermore, the data indicates that the modifications of the test section inlet have improved the flow quality, since the turbulent case shows the typical full profile near the surface. However, even though the “assumed laminar” case approaches the parabolic approximation, there are some differences. This has been attributed to the great ambiguity involved in defining the boundary layer thickness during the initial test phase.

Subsequent to a number of modifications that aimed at enhancing both the flow conditions and the measurement techniques employed, the boundary layer velocity profile as shown in FIG. 9 has been obtained from the wall normal traverse of a purpose-built miniature flattened Pitot tube, providing for a surprisingly close match to the parabolic approximation of Equation 2, and thus for confidence that proof of concept of the method proposed by the invention has been achieved.

The invention is not limited to the embodiments described but may be varied in construction and detail. For example, the drum may be adapted to support an object protruding from the drum's surface. Also, the drum may be hollow, in which case it may be perforated, and in which case there may be introduction of fluid with or without particles through the drum wall for the purpose of flow visualisation and/or boundary layer control. If the drum is perforated this may allow for fluid being blown into the test section in the form of small jets, or withdrawn from it by suction, whereby it may be most convenient to connect the required pressure systems to the centre rod of the drum. Additionally or alternatively, he drum's surface might have a number of holes (or very thin slots) to allow for the introduction of smoke (or micron-sized seeding particles) into the fluid adjacent to the rotational drum, in order to improve smoke flow visualization or Particle Image Velocimetry (PIV). The required holes may be normal to the surface or at an angle.

1. An apparatus for testing effects of relative movement of a fluid and an object, the apparatus comprising:
a test chamber arranged to contain a fluid;
a drive for moving a movable surface with respect to the fluid in the chamber; and
a probe for monitoring fluid conditions within the test chamber.

2. The apparatus as claimed in claim 1, wherein the chamber is open in a manner to allow fluid inlet and/or outlet while the movable surface is moving.

3. The apparatus as claimed in claim 1, wherein the chamber is open in a manner to allow fluid inlet and/or outlet while the movable surface is moving; and wherein the chamber has an inlet and a separate outlet.

4. The apparatus as claimed in claim 1, wherein the drive is arranged to rotate a rotor having the movable surface.

5. The apparatus as claimed in claim 1, wherein the drive is arranged to rotate a rotor having the movable surface; and wherein the chamber is curved around the path of the movable surface.

6. The apparatus as claimed in claim 1, wherein the chamber is open in a manner to allow fluid inlet and/or outlet while the movable surface is moving; and wherein the chamber has an inlet and a separate outlet; and further comprising a conduit for fluid flow into the inlet.

7. The apparatus as claimed in claim 1, wherein the chamber is open in a manner to allow fluid inlet and/or outlet while the movable surface is moving; and wherein the chamber has an inlet and a separate outlet; and further comprising a conduit for fluid flow into the inlet; and wherein the conduit includes a narrowing section.

8. The apparatus as claimed in claim 1, wherein the chamber is open in a manner to allow fluid inlet and/or outlet while the movable surface is moving; and wherein the chamber has an inlet and a separate outlet; and further comprising a conduit for fluid flow into the inlet; and wherein said narrowing section is preceded by a settling section of larger cross-sectional area.

9. The apparatus as claimed in claim 1, wherein the chamber is open in a manner to allow fluid inlet and/or outlet while the movable surface is moving; and wherein the chamber has an inlet and a separate outlet; and further comprising a conduit for fluid flow into the inlet; and wherein said narrowing section is preceded by a settling section of larger cross-sectional area; and wherein the settling section includes a flow conditioner such as a honeycomb structure or a wire gauze.

10. The apparatus as claimed in claim 1, wherein the chamber is open in a manner to allow fluid inlet and/or outlet while the movable surface is moving; and wherein the chamber has an inlet and a separate outlet; and wherein the outlet is linked with a downstream diffuser.

11. The apparatus as claimed in claim 1, further comprising means to introduce the probe from a wall of the test chamber.

12. The apparatus as claimed in claim 1, further comprising means for introducing one or more particles into the test chamber.

13. The apparatus as claimed in claim 1, further comprising means for introducing one or more particles into the test chamber; and wherein the apparatus comprises a support for supporting a particle in the test chamber.

14. The apparatus as claimed in claim 1, further comprising means for introducing one or more particles into the test chamber; and wherein the apparatus comprises a support for supporting a particle in the test chamber; and wherein the support comprises a rod.

15. The apparatus as claimed in claim 1, further comprising means for introducing one or more particles into the test chamber; and wherein the apparatus comprises a support for supporting a particle in the test chamber; and wherein the rod is movable to adjust position of the particle with respect to the movable surface.

16. The apparatus as claimed in claim 1, further comprising means for introducing one or more particles into the test chamber; and wherein the apparatus comprises a support for supporting a particle in the test chamber; and wherein the rod is movable to adjust position of the particle with respect to the movable surface; and wherein the support is adapted to mote a particle in directions either normal to the movable surface or in the direction of a fluid stream as the surface is moving.

17. The apparatus as claimed in claim 1, further comprising means for introducing one or more particles into the test chamber; and wherein the apparatus comprises a support for supporting a particle in the test chamber; and wherein the support is adapted to move a particle to simulate an impact of the particle with the movable surface.

18. The apparatus as claimed in claim 1, further comprising means for changing pressure in the test chamber.

19. The apparatus as claimed in claim 1, further comprising means for introducing pressure gradients into the test chamber.

20. The apparatus as claimed in claim 1, further comprising means for changing temperature in the test chamber.

21. A method of testing fluid conditions near a boundary layer where there is relative movement of a surface and surrounding fluid, the method comprising the steps of:
moving the movable surface of an apparatus comprising:
a test chamber arranged to contain a fluid;
a drive for moving a movable surface with respect to the fluid in the chamber; and
a probe for monitoring fluid conditions within the test chamber;
introducing at least one particle into the test chamber adjacent to the movable surface; and
monitoring fluid conditions within the test chamber.
